(19) United States
(12) Patent Application Publication
(10) Pub. No.: US 2011/0107208 A1
(43) Pub. Date: May 5, 2011

(54) Methods for Status Components at a Wireless Communication Device

(75) Inventor: Jeyprakash Michaelraj, San Jose, CA (US)

(73) Assignee: MOTOROLA, INC., Schaumburg, IL (US)

(21) Appl. No.: 12/612,069

(22) Filed: Nov. 4, 2009

(51) Int. Cl. G06F 3/01; G06F 3/033; G06F 3/048

(52) U.S. Cl. 715/702; 715/863; 715/786

(57) ABSTRACT

Methods for status components at a wireless communication device are disclosed. In an example method, a first selectable region and a second selectable region are displayed at a gesture-sensitive display, in which the second selectable region includes a first image and a second image. A user input is detected at the gesture-sensitive display corresponding to the selection of the second selectable region. The status components are displayed at the gesture-sensitive display in response to the user input, in which a status component of the status components corresponds to a property of the wireless communication device.

### FIELD OF THE INVENTION

The present invention relates generally to the field of user interfaces of wireless communication devices and, more particularly, to wireless communication devices having gesture-sensitive displays and providing status components.

### BACKGROUND OF THE INVENTION

Wireless communication devices designed for mobile users often have small screen displays. These small displays result in limited space for displaying content and receiving input from the user. This problem is particularly applicable to devices having touch-sensitive displays. For example, many graphical elements on a touch-sensitive display are sized too small in scale to discern the selection of one element from its neighboring elements via a finger touch.

In certain operating systems, such as the Open Handset Alliance™ Android™ operating system, it is common to see a toolbar region spanning the width of the screen. These toolbars typically include graphical icons and allow touch or gesture invocation of the toolbar region to generate a pull-down window list. This pull-down window list, however, only contains a subset of items representing notification of external events and associated with the graphical icons because of the lack of screen space.

The current solution to the problem of accessing the remaining subset of items is to provide separate menu structures. These menu structures are complicated and non-intuitive, having multi-level depth and requiring focused time and attention from users in the form of button presses, gestures, and screen taps for user interface navigation.

For example, some wireless communication devices display a battery strength icon on a default screen as a high-level view of the battery strength property. To view detailed information about the battery strength, however, the user is required to invoke a settings widget to launch a menu, select an “about phone” option, select a “status” option, and then select a “battery level” option. This example user/menu interaction illustrates the indirect and often confusing relationship between the battery strength icon and the detailed information behind this icon. A direct route is needed from the default screen icon representations to the displaying and if applicable altering of the wireless communication system properties represented by these icons.

### SUMMARY

There is disclosed an efficient and user-friendly communication device, and a method thereof, that minimizes required user interaction with the communication device. The method involves a simple user interaction that requires less time and effort from the user than what is found in the prior art.

An aspect of the present invention is a wireless communication device comprising a gesture-sensitive surface, a user interface, and one or more transceivers. The user interface displays regions and images (e.g., icons) and produces an input signal in response to detecting a predetermined gesture or a touch at the gesture-sensitive surface. The regions may be any size, such as half the screen width, or configured to the size of a finger (e.g., the user's index finger). In response to the input signal, the user interface may display one or more status components corresponding to the images and to a property of the wireless communication device.

### BRIEF DESCRIPTION OF THE DRAWINGS

FIG. 1 is front planar view of an example wireless communication device illustrating a first aspect of the present invention.

FIG. 2 is front planar view of an example wireless communication device illustrating a second aspect of the present invention.

FIG. 3 is a block diagram of an example wireless communication device illustrating an environment of use for the present invention.

FIG. 4 is a flowchart diagram of an example operation of the wireless communication device in accordance with the present invention.

### DETAILED DESCRIPTION OF THE EMBODIMENTS

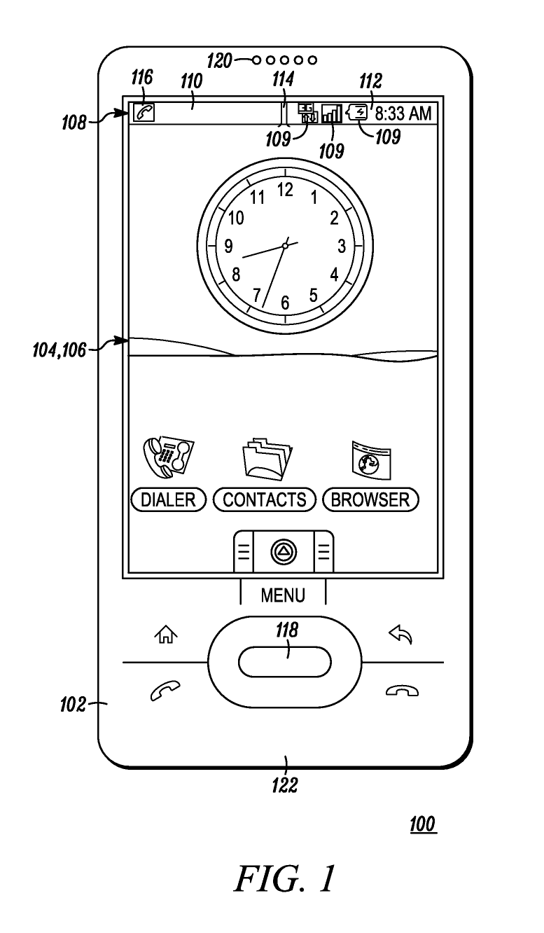

FIG. 1 illustrates a front planar view of an example wireless communication device 100. The wireless communication device 100 is preferably a portable radiotelephone; however, the wireless communication device 100 may be any device having a capability to communicate wirelessly, such as, but not limited to, a portable video player (PVP), wireless local area network (WLAN)-based mobile phones, a wireless personal digital assistant (PDA), a personal navigational device (PND), and a cordless telephone.

For one embodiment, the communication device 100 has a housing comprising a housing surface 102 which includes a visible display 104 and a user interface. For example, the user interface may be a touch-sensitive surface 106 that overlays the display 104. With the touch-sensitive surface 106 overlaying the display 104, the display may provide feedback associated with a predetermined gesture as the predetermined gesture is detected. For another embodiment, the user interface of the wireless communication device 100 may include the touch-sensitive surface 106 supported by the housing and does not overlay any type of display.

The display 104 of the wireless communication device 100 may be partitioned into a plurality of regions for providing specific functionality in each region. For example, the display 104 may provide a device toolbar 108 for indicating device status and/or general information like the one or more graphical icons 109. The graphical icons 109 may be a phone notification icon, a 3G status level status icon, a cellular signal strength status icon, a battery level status icon, or any other notification or status icon.

The toolbar 108 may be further partitioned into a first selectable region 110 separated from a second selectable region 112 by a region divider 114. The region divider 114 may be displayed as in this embodiment to visually separate the first selectable region 110 from the second selectable region 112, or it may be omitted. By graphically and logically separating the first selectable region 110 from the second selectable region 112, previously unused space is used in order to differentiate between subsets of icons and functionality. For example, in one aspect, the first selectable region 110 and the second selectable region 112 may be sized to a finger of a user of the wireless communication device 100 to optimize the available space or may be optimized to size of an average user's finger size. Additionally, more selectable regions than the two mentioned here may be added dynamically or statically to the toolbar 108.

While the toolbar 108 is illustrated in FIG. 1 as having a width of 100% of the total width of the visible display 104 and a length of 1/10 of the total length of the visible display, one of ordinary skill in the art will note that the dimensions shown in FIG. 1 are illustrative of an example implementation and may be substantially different than those shown. Additionally, the location of the toolbar 108 may be at the top of the visible display 104 as shown in FIG. 1, however it may also be on the left side of the display, the right side of the display, the bottom of the display, free floating, or any other configuration that is convenient to the user of the wireless communication device 100.

The length, width, and location of the toolbar 108 may also be altered dynamically by the user. For example, a predefined gesture may be associated with moving the toolbar 108 from one location to another location and/or changing the length or width of the toolbar.

For yet another embodiment, the user interface of the wireless communication device 100 may include one or more input keys 118 used in conjunction with the touch-sensitive surface 106. Examples of the input key or keys 118 include, but are not limited to, keys of an alpha or numeric keypad, a physical keys, touch-sensitive surfaces, multipoint directional keys. The wireless communication device 100 may also comprise apertures 120, 122 for audio output and input at the surface. It is to be understood that the wireless communication device 100 may include a variety of different combination of displays and interfaces.

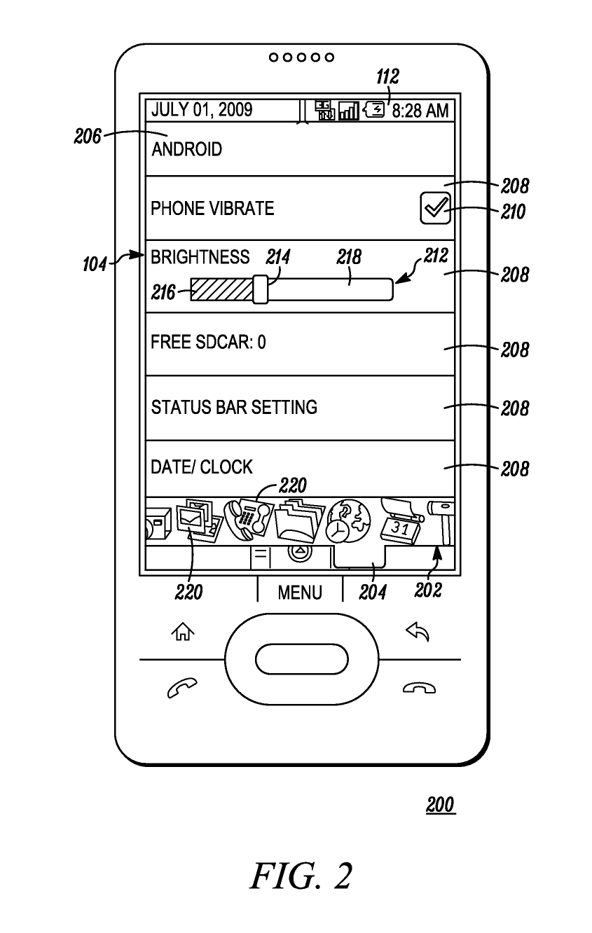

FIG. 2 illustrates the second aspect 200 of the front planar view of the wireless communication device 100. The second aspect 200 comprises a graphical pull-down window 202. In one embodiment, a user of the wireless communication device 100 may select the second selectable region 112 by touching a portion of the visible display 104 corresponding to the second selectable region. Once selected, the wireless communication device 100 displays the graphical pull-down window 202 and may additionally display a pull/push window handle 204 on the visible display 104. The user may select the pull/push window handle 204 via touch or gesture to adjust the size of the graphical pull-down window 202 or to close the graphical pull-down window.

The graphical pull-down window 202 includes an application header section 206 for displaying the name of the window. While this application header section 206 displays “Android” in this example, any descriptive string of alphanumeric characters may be used.

The graphical pull-down window 202 additionally includes a plurality of status components 208. The status components 208 represent one or more properties of the wireless communication device 100. For example, a status component of the status component 208 is shown with a “Phone Vibrate” label representing a mechanical output component such as a vibrating or motion-based mechanism.

The status components 208 may include one or more toggle button controls 210, one or more slider controls 212, and/or any other controls that can be applied to status properties of the wireless communication device 100. The toggle button control 210 may be rendered as a checkbox control, a radio button control, or any other control that can represent a Boolean data structure. By selecting the toggle button control 210, the user of the wireless communication device 100 may enable or disable properties, for example enabling or disabling of a mechanical output component, a cellular wireless transceiver component, a WLAN transceiver component, etc.

The slider control 212 includes the slider handle 214, which may be dragged in a linear direction, for example left and/or right, to change a property of the display 104, such as increasing/decreasing a level of brightness 216 or a level of darkness 218 respectively. For example, the level of brightness 216 and the level of darkness 218 represents opposite relationships of the luminescent property of the visible display 104.

The graphical pull-down window 202 may additionally contain a launcher icon 220 for invoking applications stored on the wireless communication device 100 or for connecting to services and portals via wireless communication remote to the wireless communication device 100.

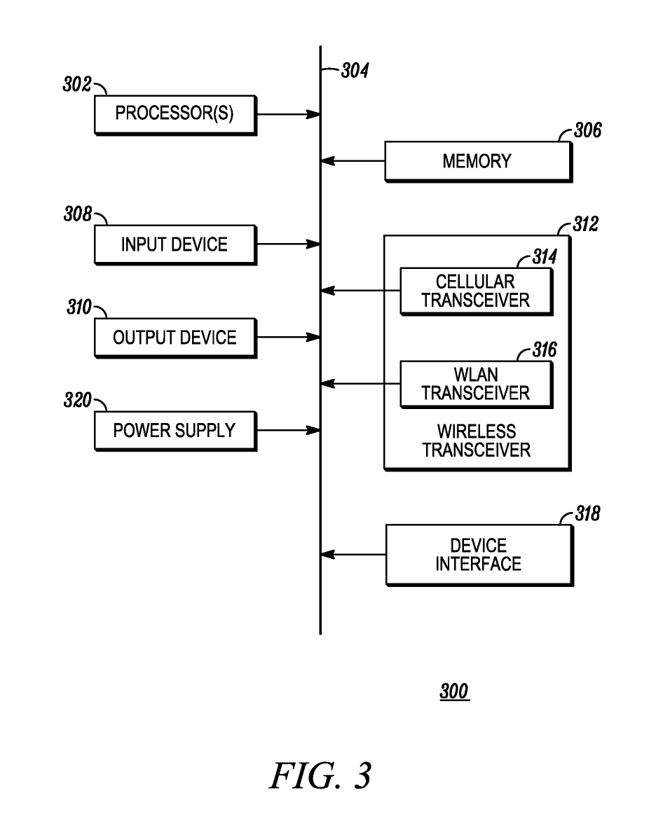

FIG. 3 illustrates an environment of use of a plurality of components 300 comprising a processor 302 electrically coupled by a system interconnect 304 to a memory device 306, an input device 308, an output device 310, and one or more wireless transceivers 312, such as a cellular transceiver 314, a WLAN transceiver 316, or any other transceiver device or combination of transceiver devices. Additionally, the components 300 includes one or more device interfaces 318 and a power source 320, such as a portable battery, for providing power to the other components and allowing portability of the wireless communication device 100.

The processor 302 provides central operation of the wireless communication device 100, such as receiving incoming data from and providing outgoing data to the wireless transceivers 312, accessing data from and storing data to the memory device 306, receiving input from one or more input device(s) 308, and providing output to one or more output device(s) 310.

The system interconnect 304 is shown in FIG. 3 as an address/data bus. Of course, a person of ordinary skill in the art will readily appreciate that interconnects other than busses may be used to connect the processor 302 to the other devices 306-320. For example, one or more dedicated lines and/or a crossbar may be used to connect the processor 302 to the other devices 306-320.

The memory device 306 operatively coupled to the processor 302 is a conventional memory device for storing data structures as well as software instructions executed by the processor 302 in a well known manner. Data may be stored by the memory device 306 include, but is not limited to, operating systems, applications, and data. Each operating system includes executable code that controls basic functions of the portable electronic device, such as interaction among the components of the components 300, communication with external devices via each wireless transceiver 312 and/or the device interfaces 320, and storage and retrieval of applications and data to and from the memory 306. Each application includes executable code utilizes an operating system to provide more specific functionality for the portable electronic device. Data is non-executable code or information that may be referenced and/or manipulated by an operating system or application for performing functions of the portable electronic device.

The memory 306 may store a plurality of gestures including the predetermined gesture. Thus, the processor 302 may retrieve information the memory 306 relating to one or more predetermined gestures, and correlate a gesture received at the user interface with one of the stored predetermined gesture.

The input device 308 may be connected to the processor 302 for entering data and commands in the form of text, touch input, gestures, etc. The input device 308 is, in one embodiment, a touch screen device but may alternatively be an infrared proximity detector or any input/output device combination capable of sensing gestures and/or touch including a touch-sensitive surface. The input device 308, may produce an input signal in response to detecting a predetermined gesture at the touch-sensitive surface. In addition, the input device 308 may include one or more additional components, such as a video input component such as an optical sensor (for example, a camera), an audio input component such as a microphone, and a mechanical input component such as button or key selection sensors, touch pad sensor, another touch-sensitive sensor, capacitive sensor, motion sensor, and switch.

The wireless communication device 100 may allow a user to provide a predetermined gesture, such as sliding one or more digits of the user's hand across a surface. Additionally or alternatively, contact with the surface without any movement along the surface such as a user press to a touch sensitive region may be provided as a gesture. Contact and movement on the surface followed by the invocation of one or more character or word recognition algorithm may be provided (e.g., one or more handwriting recognition algorithm may be implemented).

The output device 310 may generate visual indications of data generated during operation of the processor 302. The visual indications may include prompts for human operator input, calculated values, detected data, etc. As described in detail above in relation to FIG. 1, these visual indications include visual representations of the status components. Additionally, the output device 310 may include a video output component such as a cathode ray tube, liquid crystal display, plasma display, incandescent light, fluorescent light, front or rear projection display, and light emitting diode indicator. Other examples of output components 310 include an audio output component such as a speaker, alarm and/or buzzer, and/or a mechanical output component such as vibrating or motion-based mechanisms.

Each wireless transceiver 312 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants, as represented by cellular transceiver 314.

Each wireless transceiver 312 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology, as represented by the WLAN transceiver 316. Also, each wireless transceiver 312 may be a receiver, a transmitter or both.

The components 300 may further include one or more device interfaces 318 to provide a direct connection to auxiliary components or accessories for additional or enhanced functionality.

It is to be understood that FIG. 3 is provided for illustrative purposes only and for illustrating components of a portable electronic device in accordance with the present invention, and is not intended to be a complete schematic diagram of the various components required for a portable electronic device. Therefore, a portable electronic device may include various other components not shown in FIG. 3, or may include a combination of two or more components or a division of a particular component into two or more separate components, and still be within the scope of the present invention.

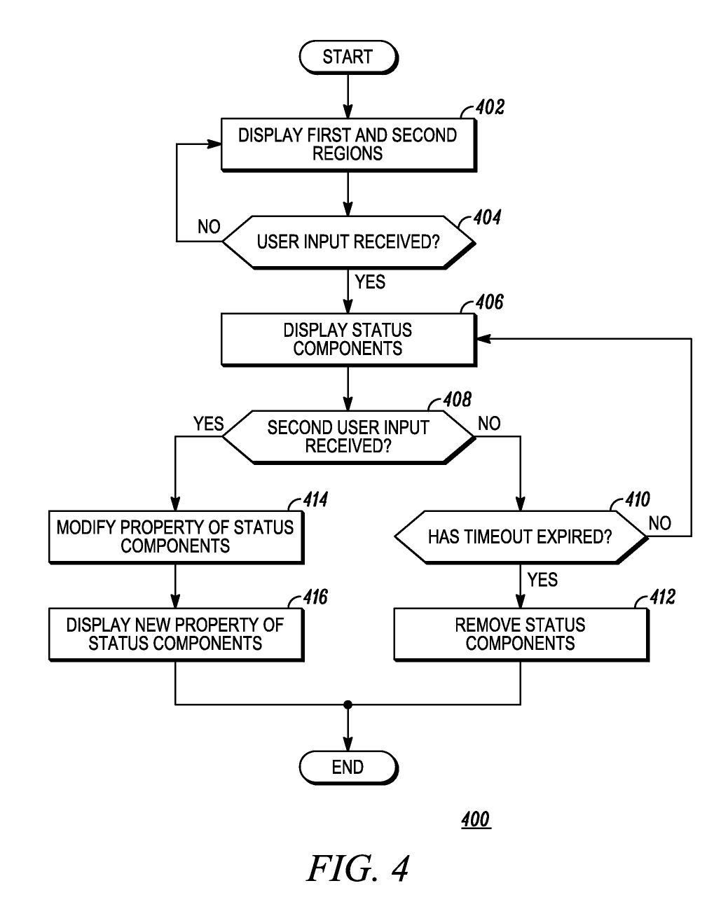

FIG. 4 is an example process 400 representative of example operation of a device and its components, such as the wireless communication device 100, 200 represented by FIGS. 1 and 2, and the components represented by FIG. 3, to implement a method for status components at a wireless communication device. For one embodiment, the illustrated process 400 may be embodied in one or more software programs which are stored in one or more memories (e.g., memory 306) and executed by one or more processors (e.g., processor 302). However, at least some of the blocks of the process 400 may be performed manually and/or by some other device. Although the process 400 is described with reference to the flowchart illustrated in FIG. 4, a person of ordinary skill in the art will readily appreciate that many other variations of performing the process 400 may be used without diverting from the scope of the present invention. For example, the order of many of the blocks may be altered, the operation of one or more blocks may be changed, blocks may be combined, and/or blocks may be eliminated.

Generally, the process 400 causes the processor 302 to display and allow access to status components at the wireless communication device 100. Starting at step 402, the wireless communication device 100 displays a first and second region on the visible display 104. For example, the first and second regions may be displayed similar to the first selectable region 110 and the second selectable region 112 respectively.

If a user selects a region at step 404, the wireless communication device 100 proceeds to step 406, otherwise wireless communication device 100 returns to step 402. For example, the selection may be implemented as an electronic interrupt received by the processor 302 in response to a user of the wireless communication device 100 touching or gesturing at the touch-sensitive surface 106.

After the wireless communication device 100 receives the selection of the region at step 404, the wireless communication device 100 displays the plurality of status components 208 are displayed to the visible display 104 at step 406.

If the user selects a property control of the wireless communication device 100, such as the toggle button control 210 or the slider control 212 at step 408, a property of the wireless communication device 100 is modified at step 414 and the new property of the wireless communication device 100 is displayed at step 416. For example, selection of the toggle button control 210 may enable a vibration mechanism, such as the output device 310, of the wireless communication device 100 if it is disabled and may disable the vibration mechanism of the wireless communication device 100 if it is enabled. Additionally, selection of slider control 212 via a left dragging gesture of the slider handle 214 may reduce the brightness property of the visible display 104 and a right dragging gesture of the slider handle 214 may increase the brightness property of the visible display 104.

Otherwise, if the user does not select a property control at step 408 within a time duration, a timeout may expire such as in step 410 and the plurality of status components 208 may be removed from the visible display 104 as shown in step 406. Alternatively, the second user input at step 408 may be a selection of the launcher icon 220. If the launcher icon 220 is selected, applications stored on the wireless communication device 100, such as calendaring software, e-mail software, etc., may be invoked or a connection to a service or portal, such as Google Maps™, via a wireless connection, such as the cellular transceiver 314 or the WLAN transceiver 316 connection, to a remote device, e.g., a Google™ server.

Although the above discloses example systems including, among other components, software executed on hardware, it should be noted that such systems are merely illustrative and should not be considered as limiting. For example, it is contemplated that any or all of the disclosed hardware and software components could be embodied in dedicated hardware, in software, in firmware or in some combination of hardware, firmware and/or software.

In addition, although certain methods, apparatus, and articles of manufacture have been described herein, the scope of coverage of this patent is not limited thereto. On the contrary, this patent covers all apparatuses, methods and articles of manufacture fairly falling within the scope of the appended claims either literally or under the doctrine of equivalents.

What is claimed is:

1. A method for status components at a wireless communication device, the method comprising:
displaying a first selectable region and a second selectable region at a gesture-sensitive display, wherein the second selectable region includes a first image and a second image;
detecting a user input at the gesture-sensitive display corresponding to a selection of the second selectable region; and
displaying a plurality of status components at the gesture-sensitive display in response to the user input, wherein a status component of the plurality of status components corresponds to a property of the wireless communication device.

2. The method of claim 1, wherein the status component corresponds to the first image.

3. The method of claim 1, wherein the first image is a wireless status image, a volume status image, or a battery status image.

4. The method of claim 1, wherein the user input is a first user input and further comprising:
detecting a second user input at the gesture-sensitive display corresponding to a selection of the status component; and
modifying the property of the wireless communication device in response to the second user input.

5. The method of claim 4, further comprising indicating the modification of the property of the wireless communication device at the gesture-sensitive display.

6. The method of claim 1, further comprising removing the status component from the gesture-sensitive display after a duration of time has elapsed.

7. The method of claim 1, wherein the status component includes a scroll bar control.

8. The method of claim 1, wherein the gesture-sensitive display includes a touch screen display.

9. The method of claim 1, wherein the gesture-sensitive display includes an infrared proximity detector.

10. The method of claim 1, wherein the user input is a first user input and further comprising:
displaying a graphical window including the plurality of status components; and
enlarging the graphical window from a first length to a second length via a second user input.

11. The method of claim 10, wherein the graphical window includes a launch tray.

12. The method of claim 10, wherein the graphical window encompasses a total width of the gesture-sensitive display.
